(19) United States
(12) Patent Application Publication
(10) Pub. No.: US 2009/0176667 A1
(43) Pub. Date: Jul. 9, 2009

(54) Expandable particulates and methods of their use in subterranean formations

(75) Inventor: Philip D. Nguyen, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 12/006,489

(22) Filed: Jan. 3, 2008

(51) Int. Cl. C09K 8/60; C09K 8/88

(52) U.S. Cl. 507/204; 507/224

(57) ABSTRACT

Methods are provided that include a method comprising providing a treatment fluid comprising at least a plurality of expandable particulates comprising a swellable elastomer composition. In some embodiments the expandable particulates may comprise a swellable elastomer and a filler material. In some embodiments the expandable particulates may comprise a solid particulate that has been at least partially coated with a swellable elastomer composition. In some embodiments, the treatment fluid may be placed into at least a portion of a subterranean formation at a pressure sufficient to create or enhance at least one fracture in the subterranean formation. Additional methods are also provided.

### BACKGROUND

The present invention relates to particulates suitable for use in subterranean applications. More particularly, at least in some embodiments, the present invention relates to expandable particulates that may be used in subterranean operations, such as hydraulic fracturing, gravel packing, frac-packing, etc.

Treatment fluids may be used in a variety of subterranean treatments, including, but not limited to, drilling operations, stimulation treatments, sand control treatments, fluid diverting treatments, cementing operations, remedial treatments, etc. As used herein, the term “treatment,” or “treating,” refers to any subterranean operation that uses a fluid in conjunction with a desired function and/or for a desired purpose. The term “treatment,” or “treating,” does not imply any particular action by the fluid or any particular component thereof.

One common production stimulation operation that employs a treatment fluid is hydraulic fracturing. Hydraulic fracturing operations generally involve pumping a treatment fluid (e.g., a fracturing fluid or a “pad” fluid) into a well bore that penetrates a subterranean formation at a hydraulic pressure sufficient to create or enhance at least one or more fractures in the subterranean formation. The fluid used in the treatment fluid may comprise particulates, which are often referred to as “proppant particulates,” that are deposited in the resultant fractures. The proppant particulates are thought to prevent the fractures from fully closing upon the release of hydraulic pressure, forming conductive channels through which fluids may flow to a well bore to ultimately be produced. The term “propped fracture” as used herein refers to a fracture (naturally-occurring or otherwise) in a portion of a subterranean formation that contains at least a plurality of proppant particulates. The term “proppant pack” refers to a collection of proppant particulates within a fracture.

Hydrocarbon-producing wells also may undergo a gravel packing treatment, inter alia, to reduce the migration of unconsolidated formation particulates into the well bore. In gravel packing operations, particulates, often referred to in the art as gravel, are suspended in a treatment fluid, which may be viscosified, and the treatment fluid is pumped into a well bore in which the gravel pack is to be placed. As the particulates are placed in or near a subterranean zone, the treatment fluid is either returned to the surface or leaks off into the zone. The resultant gravel pack acts as a filter to prevent the production of formation solids with the produced fluids. Traditional gravel pack operations may involve placing a gravel pack screen in the well bore and then packing the surrounding annulus between the screen and the well bore with gravel. The gravel pack screen is generally a filter assembly used to support and retain the gravel placed during the gravel pack operation. A wide range of sizes and screen configurations is available to suit the characteristics of a well bore, the production fluid, and any particulates in the subterranean formation.

In some situations, hydraulic fracturing and gravel packing operations may be combined into a single treatment. Such treatments are often referred to as “frac pack” operations. In some cases, the treatments are generally completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack.

Hydrocarbon wells are often located in subterranean formations that contain unconsolidated particulates (e.g., sand, gravel, proppant, fines, etc.) that may migrate out of the subterranean formation into a well bore or may be produced with the oil, gas, water, or other fluids produced by the well. The presence of such particulates in produced fluids is undesirable in that the particulates may abrade pumping and other producing equipment or reduce the production of desired fluids from the well. Moreover, particulates that have migrated into a well bore (e.g., inside the casing or perforations in a cased hole), among other things, may clog portions of the well bore, hindering the production of desired fluids from the well. The term “unconsolidated particulates,” and derivatives thereof, is defined herein to include loose particulates and particulates bonded with insufficient bond strength to withstand the forces created by the production of fluids through the formation. Unconsolidated particulates may comprise, among other things, sand, gravel, fines and proppant particulates in the subterranean formation, for example, proppant particulates placed in the subterranean formation in the course of a fracturing or gravel-packing operation.

In addition to particulate migration, an additional problem that may occur in producing hydrocarbons is the production of water. The production of water with hydrocarbons from wells often constitutes a major problem and expense in the production of oil and gas. While oil and gas wells are usually completed in hydrocarbon producing zones, a water bearing zone may occasionally be present adjacent to the hydrocarbon producing zone. In some circumstances, the higher mobility of the water may allow it to flow into the hydrocarbon producing zone by way of, inter alia, fractures or high permeability streaks. In some circumstances, the ratio of water to hydrocarbons recovered may become sufficiently high such that the cost of producing, separating, and disposing of the water may represent a significant economic loss.

### SUMMARY

The present invention relates to particulates suitable for use in subterranean applications. More particularly, at least in some embodiments, the present invention relates to expandable particulates that may be used in subterranean operations, such as hydraulic fracturing, gravel packing, frac-packing, etc.

In one embodiment, the present invention provides a method comprising providing a treatment fluid comprising at least a plurality of expandable particulates, wherein at least a portion of the expandable particulates comprise a solid particulate that has been at least partially coated with a swellable elastomer composition; placing the treatment fluid into a subterranean formation; and contacting at least a portion of the expandable particulates with a hydrocarbon fluid.

In another embodiment, the present invention provides a method comprising providing a treatment fluid comprising at least a plurality of expandable particulates, wherein at least a portion of the expandable particulates comprise a swellable elastomer composition comprising a swellable elastomer and a filler material; placing the treatment fluid into a subterranean formation; and contacting at least a portion of the expandable particulates with a hydrocarbon fluid.

In another embodiment, the present invention provides a method comprising providing a fracturing fluid comprising at least a plurality of expandable particulates comprising a swellable elastomer composition; placing the fracturing fluid into a subterranean formation at a pressure sufficient to create or enhance a fracture therein; and contacting at least a portion of the expandable particulates with a hydrocarbon fluid.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to particulates suitable for use in subterranean applications. More particularly, at least in some embodiments, the present invention relates to expandable particulates that may be used in subterranean operations, such as hydraulic fracturing, gravel packing, frac-packing, etc.

Although expandable particulates of the present invention may be useful in a variety of subterranean applications, at least in some embodiments, they may be particularly useful in hydraulic fracturing, gravel-packing, and frac-packing. In accordance with the present invention, expandable particulates may be placed in a treatment fluid, placed in a subterranean formation, and contacted with a selected fluid so that the expandable particulates may swell or expand within the subterranean formation. Thus, the compositions and methods of the present invention may be useful, inter alia, to stabilize a proppant pack in a fracture, stabilize particulate material in a gravel pack, to fill up void spaces behind a cement sheath, casing, pipe, or sand control screen, and/or to reduce the production of undesired fluid, including water and hydrocarbons, from the subterranean formation. Void spaces existing behind a cement sheath, casing, pipe, and/or sand control screen are undesirable because they may destabilize the integrity of the formation, which may lead to failures, such as casing or well bore collapse, sand screen erosion, sand production, etc. In addition, another one of the many potential advantages of the present invention (many of which are not alluded to herein) is that expandable particulates may minimize the flow back of unconsolidated particulate material.

In accordance with at least some embodiments of the present invention, at least a plurality of expandable particulates comprising a swellable elastomer composition may be placed in a treatment fluid, and the treatment fluid may be placed into a subterranean formation. In some embodiments, the treatment fluid may optionally comprise at least a plurality of solid particulates. The expandable particulates may then be contacted with a hydrocarbon fluid, upon which the expandable particulates may swell. In some embodiments, the hydrocarbon fluid may be placed into the subterranean formation, while in other embodiments, the hydrocarbon fluid may be naturally present in the subterranean formation.

In some embodiments, the expandable particulates suitable for use in the present invention comprise a swellable elastomer composition. Swellable elastomer compositions suitable for use in the expandable particulate compositions of the present invention may include any swellable elastomer that swells upon contact with a hydrocarbon fluid. As used herein, an elastomer is characterized as swellable when it swells upon contact with a hydrocarbon fluid (e.g., natural gas, oil, etc.). In some embodiments, swellable elastomers suitable for use in the present invention may generally swell by up to 2 to 30 times of their original size. Some specific examples of suitable elastomers that may swell upon contact with a hydrocarbon fluid include, but are not limited to, natural rubber, acrylate butadiene rubber, polyacrylate rubber, isoprene rubber, choloroprene rubber, butyl rubber (IIR), brominated butyl rubber (BIIR), chlorinated butyl rubber (CIIR), chlorinated polyethylene (CM/CPE), neoprene rubber (CR), styrene butadiene copolymer rubber (SBR), sulphonated polyethylene (CSM), ethylene acrylate rubber (EAM/AEM), epichlorohydrin ethylene oxide copolymer (CO, ECO), ethylene-propylene rubber (EPM and EDPM), ethylene-propylene-diene terpolymer rubber (EPT), ethylene vinyl acetate copolymer, fluorosilicone rubbers (FVMQ), silicone rubbers (VMQ), fluoro rubbers, poly 2,2,1-bicyclo heptene (polynorborneane), alkylstyrene, crosslinked substituted vinyl acrylate copolymers and diatomaceous earth. Other swellable elastomers that behave in a similar fashion with respect to hydrocarbon fluids also may be suitable. One example of a suitable swellable elastomer includes WELLLIFE 665 additive, available from Halliburton Energy Services, Inc., Duncan, Okla. Those of ordinary skill in the art, with the benefit of this disclosure, will be able to select an appropriate swellable elastomer for use in the expandable particulate compositions of the present invention based on a variety of factors, including the application in which the expandable particulate composition will be used and the desired swelling characteristics, including but not limited to the volume expansion of the particulate, the rate of increase in volume of the particulate, and the degree of stiffness of the resulting expanded particulate.

The swellable elastomers suitable for use in the present invention may be any shape or size, including, but not limited to, spherical, fiber-like, ovoid, ribbons, etc. In some embodiments, the expandable particulates may be present in a treatment fluid in a variety of particle sizes to achieve a desired range of porosity and permeability.

In some embodiments, swellable elastomer compositions suitable for use in the present invention may further comprise a filler material. Examples of suitable filler material include non-absorbable, non-soluble filler material including ground or crushed nut shells, ground or crushed seed shells, ground or crushed fruit pits, ground or crushed processed wood, silica, alumina, fumed carbon, carbon black, graphite, mica, titanium dioxide, meta-silicate, calcium silicate, kaolin, talc, zirconia, boron, fly ash, hollow glass microspheres, and solid glass, or mixtures thereof. In those embodiments where at least a portion of the swellable elastomer composition comprises a swellable elastomer and a filler material, the amount of filler material included may be in the range of about 5% to about 85% by weight of the expandable particulates.

In some embodiments, the expandable particulates may comprise a solid particulate that has been at least partially coated with a swellable elastomer composition. The term “coated” does not imply any particular degree of coverage of the expandable particulates with a swellable elastomer composition. The solid particulates may be coated with a swellable elastomer composition by any suitable method as recognized by one skilled in the art with the benefit of this disclosure. The swellable elastomer composition can be coated onto the solid particulates on-the-fly at the well site by injecting or spraying the swellable elastomer composition to one end of an auger device or sand screw containing solid particulates. The rotation or auger action of the auger device helps spread the swellable elastomer composition to coat the solid particulate. The term “on-the-fly” is used herein to mean that a flowing stream is continuously introduced into another flowing stream so that the streams are combined and mixed while continuing to flow as a single stream. In addition, the expandable particulates may be placed in a treatment fluid by any suitable method as recognized by one of skill in the art.

A wide variety of solid particulates may be used in accordance with the present invention, including, but not limited to, sand, bauxite, ceramic materials, glass materials, resin precoated proppant (e.g., commercially available from Borden Chemicals and Santrol, for example, both from Houston, Tex.), polymer materials, “TEFLON” (tetrafluoroethylene) materials, nut shells, ground or crushed nut shells, seed shells, ground or crushed seed shells, fruit pit pieces, ground or crushed fruit pits, processed wood, composite particulates, including those composite particulates prepared from a binder with filler particulate including silica, alumina, fumed carbon, carbon black, graphite, mica, titanium dioxide, meta-silicate, calcium silicate, kaolin, talc, zirconia, boron, fly ash, hollow glass microspheres, and solid glass, or mixtures thereof. The solid particulates used may have a particle size in the range of from about 2 to about 400 mesh, U.S. Sieve Series. Preferably, the solid particulates are graded sand having a particle size in the range of from about 10 to about 70 mesh, U.S. Sieve Series. Preferred sand particle size distribution ranges are one or more of 10-20 mesh, 20-40 mesh, 40-60 mesh or 50-70 mesh, depending on the particle size and distribution of the formation particulates to be screened out. In addition, solid particles suitable for use in certain embodiments of the present invention may optionally be coated with a tackifying agent and/or a resin composition.

In those embodiments where at least a portion of the expandable particulates comprise a solid particulate that has been at least partially coated with a swellable elastomer composition, the amount of swellable elastomer composition coated on the solid particulates may be in the range of about 0.1% to about 10% by weight of the solid particulates. In some embodiments, the amount of swellable elastomer composition coated on the solid particulates may be in the range of about 3% to about 6% by weight of the solid particulates. In some embodiments, the swellable elastomer composition may be coated on a solid particulate by batch mixing, partial batch mixing, or on-the-fly. Those of ordinary skill in the art, with the benefit of this disclosure, will be able to select an appropriate method for coating a swellable elastomer composition on a solid particulate based on a variety of factors, including the application in which the expandable particulate composition will be used, the type of solid particulate used, and the type of swellable elastomer composition used.

Optionally, in some embodiments, expandable particulates suitable for use in the present invention may be at least partially coated with a partitioning agent. Suitable partitioning agents dissolve, degrade, or are otherwise removed from the surface of the particulate at a desired time such that the swelling performance of the swellable elastomer composition is substantially restored once the partitioning agent is substantially removed.

The use of a partitioning agent is optional, but may be desirable when the expandable particulates will be stored prior to being used. Partitioning agents that may be suitable for use in the present invention are those substances that will dissipate once the particulates are introduced to a treatment fluid, such as a fracturing or gravel packing fluid. Partitioning agents suitable for use in the present invention should not detrimentally interfere with the particulates, and should not detrimentally interfere with the treatment fluid or the subterranean operation being performed. This does not mean that the chosen partitioning agent must be inert. Rather, in some embodiments the partitioning agent may also be a treatment chemical that has a beneficial effect on the subterranean environment, or the operation, or both. When used, the partitioning agent may be coated onto the expandable particulates in an amount of about 1% to about 20% by weight of the expandable particulates.

Examples of suitable partitioning agents that will dissolve quickly in an aqueous treatment fluid include solid salts (such as rock salt, fine salt, KCl, table salt NaCl, and other solid salts known in the art), barium sulfate, lime, benzoic acid, polyvinyl alcohol, sodium carbonate, sodium bicarbonate, molybdenum disulfide, sodium hydroxide graphite, zinc, quebracho, lignin, lignite, causticized lignite, lignosulfonate, chrome lignosulfonate, napthalenesulfonate, uintahite (gilsonite), and mixtures thereof. One skilled in the art will recognize that where lime (calcium carbonate) is chosen for use as a partitioning agent in the present invention it may be used in any of its forms, including quicklime, hydrated lime, and hydraulic lime.

The partitioning agent also may be a substance that dissipates more slowly in the presence of the treatment fluid. Partitioning agents that tend to dissolve more slowly may allow the operator more time to place the expandable particulates. Examples of suitable partitioning agents that may dissolve more slowly in an aqueous treatment fluid include calcium oxide, degradable polymers, such as polysaccharides; chitins; chitosans; proteins; aliphatic polyesters; poly(lactides); poly(glycolides); poly(ε-caprolactones); poly(hydroxybutyrates); poly(anhydrides); aliphatic polycarbonates; poly(ortho esters); poly(amino acids); poly(ethylene oxides); and poly(phosphazenes); and mixtures thereof.

Where the treatment fluid is a hydrocarbon treatment fluid, examples of suitable partitioning agents that may dissolve in a hydrocarbon treatment fluid include wax, gilsonite, sulfonated asphalt, naphthalenesulfonate, oil soluble resins, and combinations thereof. Some suitable oil soluble resins include, but are not limited to, styrene-isoprene copolymers, hydrogenated styrene-isoprene block copolymers, styrene ethylene/propylene block copolymers, styrene isobutylene copolymers, styrene-butadiene copolymers, polybutylene, polystyrene, polyethylene-propylene copolymers, and combinations thereof.

In some embodiments, a partitioning agent may also perform other functions. For example, a partitioning agent may act as a scale inhibitor, corrosion inhibitor, paraffin remover, gel breaker, crosslink de-linker, gas hydrate inhibitor, or any other solid treatment chemical that can be coated on an expandable particulate to at least temporarily inhibit or minimize the interaction between the particulates.

Any treatment fluid suitable for a subterranean operation may be used in accordance with the methods of the present invention, including aqueous fluids, non-aqueous fluids, aqueous gels, viscoelastic surfactant gels, foamed gels and emulsions. Examples of suitable aqueous fluids include fresh water, saltwater, brine, seawater, and/or any other aqueous fluid that does not adversely react with the other components used in accordance with this invention or with the subterranean formation. Examples of suitable non-aqueous fluids include organic liquids, such as hydrocarbons (e.g., kerosene, xylene, toluene, or diesel), oils (e.g., mineral oils or synthetic oils), esters, and the like. Suitable aqueous gels are generally comprised of an aqueous fluid and one or more gelling agents. Suitable emulsions may be comprised of two immiscible liquids such as an aqueous liquid or gelled liquid and a hydrocarbon. Foams may be created by the addition of a gas, such as carbon dioxide or nitrogen. In certain embodiments of the present invention, the treatment fluids are aqueous gels comprised of an aqueous fluid, a gelling agent for gelling the aqueous fluid and increasing its viscosity, and, optionally, a crosslinking agent for crosslinking the gel and further increasing the viscosity of the fluid. The increased viscosity of the gelled, or gelled and cross-linked, treatment fluid, inter alia, reduces fluid loss and allows the treatment fluid to transport significant quantities of suspended particulates. The density of the treatment fluid can be increased to provide additional particle transport and suspension in the present invention.

A variety of gelling agents may be used, including hydratable polymers that contain one or more functional groups such as hydroxyl, carboxyl, sulfate, sulfonate, amino, or amide groups. Suitable gelling agents typically comprise polymers, synthetic polymers, or a combination thereof. A variety of gelling agents may be used in conjunction with the methods of the present invention, including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. In some embodiments, the gelling agents may be polymers comprising polysaccharides, and derivatives thereof that contain one or more of these monosaccharide units: galactose, mannose, glucoside, glucose, xylose, arabinose, fructose, glucuronic acid, or pyranosyl sulfate. Examples of suitable polymers include, but are not limited to, guar gum and derivatives thereof, such as hydroxypropyl guar and carboxymethylhydroxypropyl guar, cellulose derivatives, such as hydroxyethyl cellulose, xanthan, diutan, schleroglucan, and their derivatives. Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone. In other embodiments, the gelling agent molecule may be depolymerized. The term “depolymerized,” as used herein, generally refers to a decrease in the molecular weight of the gelling agent molecule. Depolymerized gelling agent molecules are described in U.S. Pat. No. 6,488,091 issued Dec. 3, 2002 to Weaver, et al., the relevant disclosure of which is incorporated herein by reference. Suitable gelling agents that may be used in conjunction with the methods of the present invention may be present in the treatment fluid in an amount in the range of about 0.01% to about 5% by weight of the aqueous fluid therein. In some embodiments, the gelling agents may be present in the treatment fluid in an amount in the range of about 0.01% to about 2% by weight of the aqueous fluid therein.

Crosslinking agents may be used to crosslink gelling agent molecules to form crosslinked gelling agents. Crosslinkers typically comprise at least one metal ion that is capable of crosslinking molecules. Examples of suitable crosslinkers include, but are not limited to, zirconium compounds (such as, for example, zirconium lactate, zirconium lactate triethanolamine, zirconium acetylacetonate, zirconium citrate, and zirconium diisopropylamine lactate); titanium compounds (such as, for example, titanium lactate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof. An example of a suitable commercially available zirconium-based crosslinker is CL-24 available from Halliburton Energy Services, Inc., Duncan, Okla. An example of a suitable commercially available titanium-based crosslinker is CL-39 available from Halliburton Energy Services, Inc., Duncan, Okla. Suitable crosslinkers that may be used in conjunction with the present invention may be present in the treatment fluid in an amount sufficient to provide, inter alia, the desired degree of crosslinking between gelling agent molecules. In some embodiments of the present invention, the crosslinkers may be present in the treatment fluid in an amount in the range of about 0.001% to about 10% by weight of the aqueous fluid therein. In other embodiments of the present invention, the crosslinkers may be present in the treatment fluid in an amount in the range of about 0.01% to about 1% by weight of the aqueous fluid therein. Individuals skilled in the art, with the benefit of this disclosure, will recognize the exact type and amount of crosslinker to use depending on factors such as the specific gelling agent, desired viscosity, and formation conditions.

The gelled or gelled and cross-linked treatment fluids may also include internal delayed gel breakers such as enzyme, oxidizing, acid buffer, or temperature-activated gel breakers. The gel breakers cause the viscous treatment fluids to revert to thin fluids that can be produced back to the surface after they have been used to place particulates in subterranean fractures. The gel breaker used is typically present in the treatment fluid in an amount in the range of about 0.5% to about 10% by weight of the gelling agent. The treatment fluids may also include one or more of a variety of well-known additives, such as gel stabilizers, fluid loss control additives, clay stabilizers, bactericides, and the like.

Generally, expandable particulates suitable for use in the present invention may be present in a treatment fluid in an amount believed to be sufficient to stabilize a proppant pack in a fracture, stabilize particulate material in a gravel pack, reduce the production of undesired water or hydrocarbon from the subterranean formation, minimize the flow back of unconsolidated particulate material, or to perform another desired function. In some embodiments, expandable particulates may be present in an amount in the range of about 0.01 pound per gallon (ppg) to about 30 ppg of the treatment fluid. In other embodiments, the expandable particulates may be present in an amount in the range of about 1 ppg to about 10 ppg of the treatment fluid. While these ranges may be suitable in certain embodiments, any amount within the disclosed range may also be suitable. Those of ordinary skill in the art, with the benefit of this disclosure, will be able to select an appropriate amount of the expandable particulates to include in a treatment fluid based on a variety of factors, including the application in which the treatment fluid will be used and the desired swelling characteristics.

In one embodiment, the present invention provides a method comprising providing a treatment fluid comprising at least a plurality of expandable particulates, wherein at least a portion of the expandable particulates comprise a solid particulate that has been at least partially coated with a swellable elastomer; placing the treatment fluid into a subterranean formation; and contacting at least a portion of the expandable particulates with a hydrocarbon fluid.

In another embodiment, the present invention provides a method comprising providing a treatment fluid comprising at least a plurality of expandable particulates, wherein at least a portion of the expandable particulates comprise a swellable elastomer and a filler material; placing the treatment fluid into a subterranean formation; and contacting at least a portion of the expandable particulates with a hydrocarbon fluid.

In another embodiment, the present invention provides a method comprising providing a fracturing fluid comprising at least a plurality of expandable particulates comprising a swellable elastomer; placing the fracturing fluid into a subterranean formation at a pressure sufficient to create or enhance a fracture therein; and contacting at least a portion of the expandable particulates with a hydrocarbon fluid.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

What is claimed is:

1. A method comprising:
providing a treatment fluid comprising at least a plurality of expandable particulates, wherein at least a portion of the expandable particulates comprise a solid particulate that has been at least partially coated with a swellable elastomer composition;
placing the treatment fluid into a subterranean formation; and
contacting at least a portion of the expandable particulates with a hydrocarbon fluid.

2. The method of claim 1 wherein the swellable elastomer composition comprises at least one swellable elastomer selected from the group consisting of: natural rubber, acrylate butadiene rubber, polyacrylate rubber, isoprene rubber, choloroprene rubber, butyl rubber, brominated butyl rubber, chlorinated butyl rubber, chlorinated polyethylene, neoprene rubber, styrene butadiene copolymer rubber, sulphonated polyethylene, ethylene acrylate rubber, epichlorohydrin ethylene oxide copolymer, ethylene-propylene rubber, ethylene-propylene-diene terpolymer rubber, ethylene vinyl acetate copolymer, fluorosilicone rubbers, silicone rubbers, fluoro rubbers, poly 2,2,1-bicyclo heptene, alkylstyrene, crosslinked substituted vinyl acrylate copolymers, and diatomaceous earth.

3. The method of claim 1 wherein the solid particulate comprises at least one solid particulate selected from the group consisting of: sand, bauxite, ceramic materials, glass materials, resin precoated proppant, polymer materials, tetrafluoroethylene materials, nut shells, seed shells, fruit pit pieces, processed wood, and composite particulates.

4. The method of claim 1 wherein the swellable elastomer composition is coated on the solid particulate in a range of about 0.1% to about 10% by weight of the solid particulates.

5. The method of claim 1 wherein at least a portion of the expandable particulates further comprise a partitioning agent.

6. The method of claim 5 wherein the partitioning agent comprises at least one partitioning agent selected from the group consisting of: a solid salt, barium sulfate, benzoic acid, polyvinyl alcohol, sodium carbonate, sodium bicarbonate, molybdenum disulfide, sodium hydroxide graphite, zinc, lime, quebracho, lignin, lignite, causticized lignite, lignosulfonate, chrome lignosulfonate, napthalenesulfonate, uintahite, calcium oxide, and a degradable polymer.

7. The method of claim 1 wherein the swellable elastomer composition further comprises at least one filler material selected from the group consisting of: ground nut shells, crushed nut shells, ground seed shells, crushed seed shells, ground fruit pits, crushed fruit pits, ground processed wood, crushed processed wood, silica, alumina, fumed carbon, carbon black, graphite, mica, titanium dioxide, meta-silicate, calcium silicate, kaolin, talc, zirconia, boron, fly ash, hollow glass microspheres, and solid glass.

8. The method of claim 1 wherein the expandable particulates are present in the treatment fluid in an amount in the range of about 0.01 ppg to about 30 ppg of the treatment fluid.

9. The method of claim 1 wherein placing the treatment fluid into the subterranean formation comprises depositing at least a portion of the expandable particulates in a desired area in a well bore to form a gravel pack.

10. The method of claim 1 wherein placing the treatment fluid into the subterranean formation comprises placing the treatment fluid into at least a portion of the subterranean formation at a pressure sufficient to create or enhance at least one fracture in the subterranean formation.

11. The method of claim 1 wherein placing the treatment fluid into the subterranean formation comprises placing the treatment fluid into at least a portion of the subterranean formation to reduce the production of an undesired fluid.

12. A method comprising:
providing a treatment fluid comprising at least a plurality of expandable particulates, wherein at least a portion of the expandable particulates comprise a swellable elastomer composition comprising a swellable elastomer and a filler material;
placing the treatment fluid into a subterranean formation; and
contacting at least a portion of the expandable particulates with a hydrocarbon fluid.

13. The method of claim 12 wherein the swellable elastomer composition comprises at least one swellable elastomer selected from the group consisting of: natural rubber, acrylate butadiene rubber, polyacrylate rubber, isoprene rubber, choloroprene rubber, butyl rubber, brominated butyl rubber, chlorinated butyl rubber, chlorinated polyethylene, neoprene rubber, styrene butadiene copolymer rubber, sulphonated polyethylene, ethylene acrylate rubber, epichlorohydrin ethylene oxide copolymer, ethylene-propylene rubber, ethylene-propylene-diene terpolymer rubber, ethylene vinyl acetate copolymer, fluorosilicone rubbers, silicone rubbers, fluoro rubbers, poly 2,2,1-bicyclo heptene, alkylstyrene, crosslinked substituted vinyl acrylate copolymers, and diatomaceous earth.

14. The method of claim 12 wherein the filler material comprises at least one filler material selected from the group consisting of: ground nut shells, crushed nut shells, ground seed shells, crushed seed shells, ground fruit pits, crushed fruit pits, ground processed wood, crushed processed wood, silica, alumina, fumed carbon, carbon black, graphite, mica, titanium dioxide, meta-silicate, calcium silicate, kaolin, talc, zirconia, boron, fly ash, hollow glass microspheres, and solid glass.

15. The method of claim 12 wherein the expandable particulates are present in the treatment fluid in an amount in the range of about 0.01 ppg to about 30 ppg of the treatment fluid.

16. The method of claim 12 wherein placing the treatment fluid into the subterranean formation comprises depositing at least a portion of the expandable particulates in a desired area in a well bore to form a gravel pack.

17. The method of claim 12 wherein placing the treatment fluid into the subterranean formation comprises placing the treatment fluid into at least a portion of the subterranean formation at a pressure sufficient to create or enhance at least one fracture in the subterranean formation.

18. A method comprising:
providing a fracturing fluid comprising at least a plurality of expandable particulates comprising a swellable elastomer composition;
placing the fracturing fluid into a subterranean formation at a pressure sufficient to create or enhance a fracture therein; and
contacting at least a portion of the expandable particulates with a hydrocarbon fluid.

19. The method of claim 18 wherein the swellable elastomer composition comprises at least one swellable elastomer selected from the group consisting of: natural rubber, acrylate butadiene rubber, polyacrylate rubber, isoprene rubber, choloroprene rubber, butyl rubber, brominated butyl rubber, chlorinated butyl rubber, chlorinated polyethylene, neoprene rubber, styrene butadiene copolymer rubber, sulphonated polyethylene, ethylene acrylate rubber, epichlorohydrin ethylene oxide copolymer, ethylene-propylene rubber, ethylene-propylene-diene terpolymer rubber, ethylene vinyl acetate copolymer, fluorosilicone rubbers, silicone rubbers, fluoro rubbers, poly 2,2,1-bicyclo heptene, alkylstyrene, crosslinked substituted vinyl acrylate copolymers, and diatomaceous earth.

20. The method of claim 18 wherein the expandable particulates are present in the fracturing fluid in an amount in the range of about 0.01 ppg to about 30 ppg of the fracturing fluid.
